(19) United States
(12) Patent Application Publication
(10) Pub. No.: US 2021/0058998 A1
(43) Pub. Date: Feb. 25, 2021

(54) METHODS AND APPARATUS FOR PROCESSING BEAM FAILURE OF A SECONDARY CELL

(71) Applicant: NEC CORPORATION, Tokyo (JP)

(72) Inventors: Fang YUAN, Beijing (CN); Lin LIANG, Beijing (CN); Gang WANG, Beijing (CN)

(73) Assignee: NEC CORPORATION, Tokyo (JP)

(21) Appl. No.: 17/044,134

(22) PCT Filed: Apr. 4, 2018
(86) PCT No.: PCT/CN2018/081985

§ 371 Date: Sep. 30, 2020

(51) Int. Cl. H04W 76/19; H04W 72/04; H04W 24/08

(52) U.S. Cl. CPC H04W 76/19; H04W 24/08; H04W 72/0413

(57) ABSTRACT

Embodiments of the present disclosure relate to methods, devices and apparatuses of processing beam failure of a secondary cell at a terminal device and a network device respectively. In an embodiment of the present disclosure, the terminal device is serviced in a primary cell and a secondary cell on separate beams, and the secondary cell operates in a self-scheduling mode. The method may include transmitting, on an uplink control channel of the primary cell, a beam failure recovery request of the secondary cell, in response to detection of a beam failure in the secondary cell; and receiving a response to the beam failure recovery request of the secondary cell on a downlink control channel of the primary cell, wherein the response is configured to indicate a transmission configuration indication for a subsequent transmission. With embodiments of the present disclosure, a solution for supporting beam failure recovery request in the secondary cell without substantial latency or overhead issues, which makes an efficient beam failure recovery in the secondary cell possible.

### FIELD OF THE INVENTION

The non-limiting and exemplary embodiments of the present disclosure generally relate to the field of wireless communication techniques, and more particularly relate to methods, devices and apparatuses of processing beam failure of a secondary cell at a terminal device and a network device respectively.

### BACKGROUND OF THE INVENTION

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

In order to improve the data rate performance, in 3GPP Long Term Evolution (LTE), there was introduced License Assisted Access (LAA) for both downlink and uplink transmission. As the LTE network enters its next phase of evolution with the study of wider bandwidth waveform under the NR project, it is natural for the LAA networks to evolve into the 5G NR system. In addition, carrier aggregation (CA) is also used in 3GPP LTE and it is a technology to use a plurality of component carriers to serve the same user. It was also agree that the CA technology would be also supported in the NR system.

Beam failure recovery is a mechanism for recovering beams when all or part of beams serving a terminal device failed. In RAN2 #90 meeting for the 3GPP working group, it was already agreed that the beam failure recovery request (BFR) is supported in the same carrier case of CA. However, there still remains questions regarding supporting the BFR of the secondary cell (Scell) on another cell, e.g., Pcell.

### SUMMARY OF THE INVENTION

To this end, in the present disclosure, there is provided a new solution of processing beam failure of a secondary cell in a wireless communication system, to mitigate or at least alleviate at least part of the issues in the prior art.

According to a first aspect of the present disclosure, there is provided a method for processing a beam failure at a terminal device, wherein the terminal device is serviced in a primary cell and a secondary cell on separate beams, and the secondary cell operates in a self-scheduling mode. The method may include transmitting, on an uplink control channel of the primary cell, a beam failure recovery request of the secondary cell, in response to detection of a beam failure in the secondary cell; and receiving a response to the beam failure recovery request of the secondary cell on a downlink control channel of the primary cell, wherein the response is configured to indicate a transmission configuration indication for a subsequent transmission.

According to a second aspect of the present disclosure, there is provided a method for processing a beam failure at a network device, wherein a terminal device is serviced by the network device in a primary cell and a secondary cell on separate beams, and the secondary cell operates in a self-scheduling mode. The method may include receiving, on an uplink control channel of the primary cell, a beam failure recovery request of the secondary cell; and transmitting a response to the beam failure recovery request of the secondary cell on a downlink control channel of the primary cell, wherein the response is configured to indicate a transmission configuration indication for a subsequent transmission.

According to a third aspect of the present disclosure, there is provided a terminal device, wherein the terminal device is serviced in a primary cell and a secondary cell on separate beams, and the secondary cell operates in a self-scheduling mode. The terminal device may include a transceiver, configured to transmit, on an uplink control channel of the primary cell, a beam failure recovery request of the secondary cell, in response to detection of a beam failure in the secondary cell; and a receiver configured to receive a response to the beam failure recovery request of the secondary cell on a downlink control channel of the primary cell, wherein the response is configured to indicate a transmission configuration indication for a subsequent transmission.

According to a fourth aspect of the present disclosure, there is provided a network device, wherein a terminal device is serviced by the network device in a primary cell and a secondary cell on separate beams, and the secondary cell operates in a self-scheduling mode. The network device may include a receiver configured to receive, on an uplink control channel of the primary cell, a beam failure recovery request of the secondary cell; and a transceiver, configured to transmit a response to the beam failure recovery request of the secondary cell on a downlink control channel of the primary cell to indicate a transmission configuration indication for a subsequent transmission.

According to a fifth aspect of the present disclosure, there is provided a terminal device. The terminal device may comprise a processor and a memory. The memory may be coupled with the processor and having program codes therein, which, when executed on the processor, cause the terminal device to perform operations of the first aspect.

According to a sixth aspect of the present disclosure, there is provided a network device. The network device may comprise a processor and a memory. The memory may be coupled with the processor and have program codes therein, which, when executed on the processor, cause the network node to perform operations of the second aspect.

According to a seventh aspect of the present disclosure, there is provided a computer-readable storage media with computer program codes embodied thereon, the computer program codes configured to, when executed, cause an apparatus to perform actions in the method according to any embodiment in the first aspect.

According to an eighth aspect of the present disclosure, there is provided a computer-readable storage media with computer program codes embodied thereon, the computer program codes configured to, when executed, cause an apparatus to perform actions in the method according to any embodiment in the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, a solution for supporting beam failure recovery request in the secondary cell without substantial latency or overhead issues, which makes an efficient beam failure recovery in the secondary cell possible.

### BRIEF DESCRIPTION OF THE DRAWINGS

The above and other features of the present disclosure will become more apparent through detailed explanation on the embodiments as illustrated in the embodiments with reference to the accompanying drawings, throughout which like reference numbers represent same or similar components and wherein:

FIGS. 1A and 1B schematically illustrates two typical scenarios of CA in the prior art;

FIG. 2 schematically illustrates four possible related scenarios of CA between a NR carrier (Pcell) and a NR unlicensed carrier (Scell) in the prior art;

FIG. 3 schematically illustrates a solution of beam failure recovery request for the primary cell in the prior art;

FIG. 4 schematically illustrates a solution of beam failure recovery request of the secondary cell in the prior art;

FIG. 5 schematically illustrates another possible solution of beam failure recovery request of the secondary cell;

FIG. 6 schematically illustrates a flow chart of a method for processing the beam failure of the secondary cell at a terminal device according to an embodiment of the present disclosure;

FIG. 7 schematically illustrates a diagram showing a beam failure recovery request transmission of the secondary cell according to an embodiment of the present disclosure;

FIG. 8 schematically illustrates a flow chart of resource indication receiving for the beam failure recovery according to an embodiment of the present disclosure;

FIG. 9 schematically illustrates resource scheduling for the beam failure recovery for the secondary cell according to an embodiment of the present disclosure;

FIG. 10A schematically illustrates an example process of the beam failure recovery according to an embodiment of the present disclosure;

FIG. 10B schematically illustrates possible settings of monitoring ending conditions of the beam failure recovery process for the secondary cell according to an embodiment of the present disclosure;

FIG. 11 schematically illustrates possible operations related to beam failure detection according to an embodiment of the present disclosure;

FIG. 12 schematically illustrates an example reference signal measurement timing configuration in secondary cell according to an embodiment of the present disclosure;

FIG. 13 schematically illustrates an example beam failure detection in the secondary cell according to an embodiment of the present disclosure;

FIG. 14 schematically illustrate a solution for transmitting an uplink Clear Channel Assessment (CCA) failure indication according to an embodiment of the present disclosure;

FIG. 15 schematically illustrates a flow chart of a method for processing beam failure of the secondary cell at a network device according to an embodiment of the present disclosure;

FIG. 16 schematically illustrates a flow chart of a method of resource indication transmitting for the beam failure recovery according to an embodiment of the present disclosure;

FIG. 17 schematically illustrates a flow chart of a method of reference signal transmission for beam failure detection according to an embodiment of the present disclosure;

FIG. 18 schematically illustrate a solution for receiving an uplink CCA failure indication according to an embodiment of the present disclosure;

FIG. 19 schematically illustrates a block diagram of an apparatus for processing the beam failure of the secondary cell at a terminal device according to an embodiment of the present disclosure;

FIG. 20 schematically illustrates a block diagram of an apparatus for processing the beam failure of the secondary cell at a network device according to an embodiment of the present disclosure; and

FIG. 21 schematically illustrates a simplified block diagram of an apparatus 2110 that may be embodied as or comprised in a terminal device like UE, and an apparatus 2120 that may be embodied as or comprised in a network device like gNB as described herein.

### DETAILED DESCRIPTION OF EMBODIMENTS

Hereinafter, the solution as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc.]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, user equipment (UE) may refer to a terminal, a Mobile Terminal (MT), a subscriber station, a portable subscriber station, Mobile Station (MS), or an Access Terminal (AT), and some or all of the functions of the UE, the terminal, the MT, the SS, the portable subscriber station, the MS, or the AT may be included. Furthermore, in the context of the present disclosure, the term “BS” may represent, e.g., a node B (NodeB or NB), an evolved NodeB (eNodeB or eNB), gNB (next generation Node B), a radio header (RH), a remote radio head (RRH), a relay, or a low power node such as a femto, a pico, and so on.

As mentioned in Background, in RAN2 #90 meeting for the 3GPP working group, it was already agreed that the beam failure recovery request (BFR) is supported in the Pcell; however, there still remain questions of supporting the BFR in the Scell.

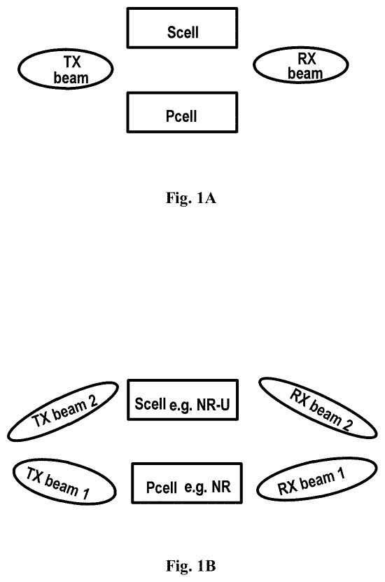

There are usually two typical scenarios of carrier aggregation (CA), as illustrated in FIGS. 1A and 1B. FIG. 1A schematically illustrates a first scenario wherein the Pcell and Scell use the same beam and thus there is no need for beam failure recovery request for Scell. In the second scenario as illustrated in FIG. 1B, the Pcell and the Scell use separate beams for Pcell and Scell and thus there might be a need for recovering the failed beam in the Scell.

In addition, there are several deployment scenarios for the carrier aggregation. In RAN1 #91 meeting, it was agreed to study the additional functionality needed beyond the specifications for operation in licensed spectrum in the following deployment scenarios:
Carrier aggregation between licensed band NR (Pcell) and NR-U (Scell)
   NR-U Scell may have both DL and UL, or DL-only.
Dual connectivity between licensed band LTE (Pcell) and NR-U (PScell)
Stand-alone NR-U
An NR cell with DL in unlicensed band and UL in licensed band
Dual connectivity between licensed band NR (Pcell) and NR-U (PScell)

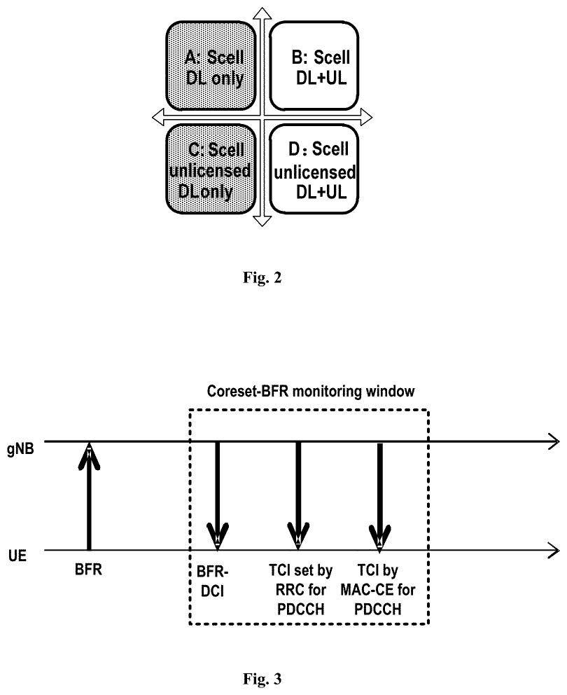

Thus, it can be seen that there are various deployment scenarios for the Pcell and the Scell. FIG. 2 schematically illustrates four possible related scenarios of CA between a NR carrier (Pcell) and a NR unlicensed carrier (Scell) in the prior art. From FIG. 2, it can be seen that the Scell can be licensed carrier or unlicensed carrier, and the Scell can have both UL and DL, or DL only. If the Scell has both UL and DL, the Scell can transmit a BFR on its UL channel; while, it still remains a question regarding how to transmit a beam failure recovery request when the Scell has only DL.

FIG. 3 schematically illustrates a solution of beam failure recovery request of the primary cell in the prior art. In NR TS38.213, it was specified that BFR for the Pcell is handled by a set of physical random channel (PRACH) resources, new beam identifier (ID) is associated with a dedicated PRACH resource and a BFR response is transmitted on dedicated control resource set or search space. As illustrated in FIG. 3, when a terminal device like UE detects a beam failure in the primary cell, the UE transmits a BFR on a PRACH resource determined based on new beam, the network device like gNB transmits a BFR-DCI (downlink control indication) on physical downlink control channel (PDCCH), as a response to the BFR to schedule resource for the subsequent transmission. After that, the network device will inform a set of transmission configuration indication (TCI) for PDCCH reception by means of a higher layer signal like Radio Resource Control (RRC) and informs the UE of a specific selected TCI from the set for PDCCH reception by medial access control (MAC) control element (CE).

At the same time, the UE will keep monitoring control resource set (CORESET) for the PDCCH in a monitoring window. In RAN1 meeting #91, it was agreed that upon receiving from the gNB a response for beam failure recovery request transmission,
the UE shall monitor CORESET-BFR for dedicated PDCCH reception until one of the following conditions is met:
   Reconfigured by gNB to another CORESET for receiving dedicated PDCCH and activated by MAC-CE a TCI state if the configured CORESET has K>1 configured TCI states,
   Re-indicated by gNB to another TCI state(s) by MAC-CE of CORESET(s) before beam failure,
Until the reconfiguration/activation/re-indication of TCI state(s) for PDCCH, UE shall assume DMRS of PDSCH is spatial QCL′ed with DL RS of the UE-identified candidate beam in the beam failure recovery request;
After the reconfiguration/activation/re-indication of TCI state(s) for PDCCH, UE is not expected to receive a DCI in CORESET-BFR.

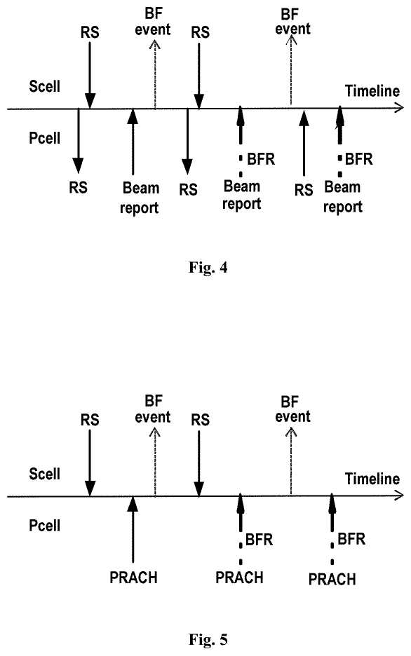

FIG. 4 schematically illustrates a solution of beam failure recovery request of the secondary cell in the prior art, which was proposed in 3GPP technical document R1-1803362. In the illustrated solution, it was proposed to handle the BFR for the Scell by means of beam reporting on Pcell. As illustrated in FIG. 4, when reference signals are transmitted on the Pcell and the Scell to the terminal device, the beam report of both the Pcell and Scell will be reported to the network device on an uplink channel of the Pcell. If a beam failure (BF) event is detected in the Scell, such an event will not be reported to the network device until the next beam reporting, as illustrated by the dashed lines with arrows. This means a large latency if the beam reporting (BR) in the Pcell is configured to have a larger periodicity. Things will be worse if the sub carrier spacing (SCS) is small in Pcell and the SCS is large in Scell. In addition, overhead might be another issue if the component carrier group is large or the BR's periodicity is small.

As another option, the Scell could use a similar beam failure recovery solution in the Pcell. FIG. 5 schematically illustrates another possible solution of beam failure recovery request of the secondary cell in the prior art. In the solution as illustrated in FIG. 5, the BFR for Scell is handled by PRACH on the Pcell just like the BFR for the Pcell. However, such a solution requires at least two sets of BFR-PRACH resources and meanwhile it is still a problem how to indicate the cc(g) index, wherein the term cc(g) index here is used to indicate an index of component carrier or component carrier group.

Thus, it can be seen that the beam failure recovery request in Scell is not well supported in these possible solutions and there is a need to enhance the BFR mechanism for the Scell. To this end, in the present disclosure, it is to propose a solution for BFR in Scell to improve the BFR support in the NR system. In the present disclosure, there is proposed a new beam failure recovery request for the Scell wherein the beam failure recovery request is transmitted on physical uplink control channel (PUCCH) instead of on a PRACH or in beam reporting. Thus, it is possible to support BFR in the Scell without a large latency or high overhead.

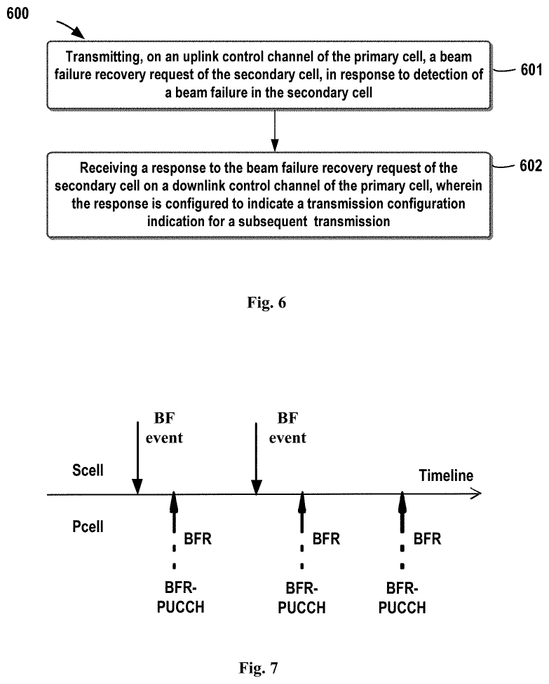

Hereinafter, reference will be further made to FIGS. 6 to 21 to describe solutions as proposed in the present disclosure in details. However, it shall be appreciated that the following embodiments are given only for illustrative purposes and the present disclosure is not limited thereto.

FIG. 6 schematically illustrates a flow chart of a method for processing the beam failure of the secondary cell at a terminal device according to an embodiment of the present disclosure. The method 600 may be performed at a terminal device, for example a terminal device like UE, or other like devices.

As illustrated in FIG. 6, in step 601, a beam failure recovery request of the secondary cell (MSG 1) is transmitted on an uplink control channel of the primary cell, in response to detection of a beam failure in the secondary cell. In other words, in embodiments of the present disclosure, an uplink control channel of the Pcell will be used to transmit the BFR for the Scell when a BF event occurs in the Scell instead of using beam reporting or PRACH on the Pcell.

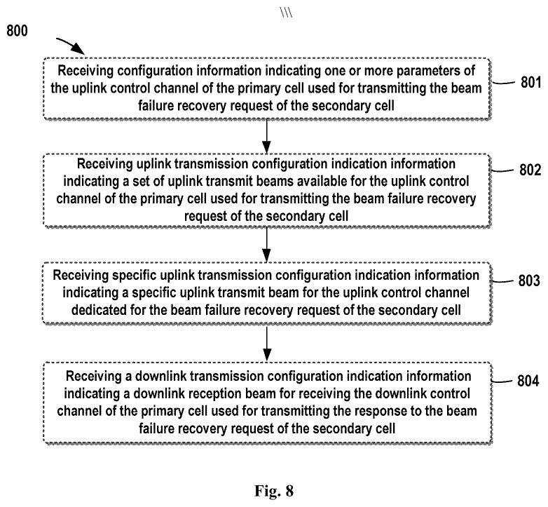

For illustrative purposes, FIG. 7 schematically illustrates a diagram of a beam failure recovery request transmission of the secondary cell according to an embodiment of the present disclosure. As illustrated in FIG. 7, when a BF event happens in the Scell, the BFR will be transmitted on a Physical Uplink Control Channel (PUCCH). The PUCCH can be configured with a smaller periodicity and thus the latency issue can be overcome. Meanwhile, the BFR transmitted on the PUCCH will not cause payload issues since all secondary cell could share the same one PUCCH of the Pcell used for transmitting the BFR of the Scell. Hereinafter, for a purpose of simplification, the PUCCH of the Pcell used for transmitting the BFR in the Scell is also called as BFR-PUCCH for short. In addition, for the CA with only DL in the Scell, such a solution could be a mandatory, while for the CA with both DL and UL in the Scell, such a solution could be optional.

The BFR-PUCCH could be pre-configured by the network device, for example by a radio resource control (RRC) signaling. Thus, as illustrated in FIG. 8, in step 801, the terminal device may receive configuration information indicating one or more parameters for the BFR-PUCCH. The parameters may include one or more of transmission periodicity, transmission offset, transmission prohibit timer, a maximum number of transmissions, etc. The transmission periodicity indicates how often the BFR-PUCCH can be transmitted, the transmission offset indicates the offset of the BFR-PUCCH with regard to for example the start boundary of subframe, the prohibit timer indicates the timings in which the BFR-PUCCH cannot be transmitted and the maximum number of transmission indicate the allowed maximum number of the BFR-PUCCH retransmissions for one beam failure event.

It can be appreciated that, although parameters of the BFR-PUCCH are configured by RRC in the above description, one or more of these parameters can be predetermined and thus are not required to be configured by any signaling.

Additionally, the beam resource for transmitting the BFR-PUCCH could be also pre-configured by the network device, for example by an RRC signaling and MAC CE. As further illustrated in FIG. 8, in step 802 the UE may receive uplink transmission configuration indication (TCI) information indicating a set of uplink transmit beams available for the uplink control channel of the primary cell used for transmitting the beam failure recovery request of the secondary cell. The transmission configuration indication information indicates the spatial resources at the terminal device side. Specifically it may indicate beams for uplink transmission or downlink reception at UE side. The uplink transmission configuration indication information is to indicate a set of uplink transmit beams which can be used for transmitting BFR-PUCCH. Next, in step 803, the UE may further receive specific uplink transmission configuration indication information for example, by MAC-CE. The specific uplink transmission configuration indication information is used to indicate a specific uplink transmit beam for the uplink control channel dedicated for the beam failure recovery request of the secondary cell, which is selected from the foresaid uplink transmission configuration indication information. In such a way, the terminal device could know which beam it shall use to transmit the BFR-PUCCH.

The operations in steps 802 and 803 provide to an explicit scheme to configure the TCI. While in another embodiment of the present disclosure, it could use an implicit scheme. For example, the beam failure recovery request of the secondary cell can be transmitted on an uplink transmit beam most recently used by the terminal device. In such a case, no explicit signaling is required.

The BFR-PUCCH carries a BFR request for the Secll which could include a plurality of bit fields. For example, it may include cc(g) index information, and new beam information including for example new beam ID and optional Reference Signal Receiving Power (RSRP). For illustrative purposes, Table 1 gives an example BFR-PUCCH format:

TABLE 1
An example BFR-PUCCH Format

| CC(g) index | C |
|---|---|
| New beam info. | Beam ID n[/RSRP n] |

In the example BFR-PUCCH format, cc(g) index wherein the cc(g) index indicates an index of component carrier or component carrier group related to the beam failure event; new beam information indicates information on a new beam with better beam quality, it could include the identifier of the new beam and optional RSRP. Thus, it only needs 9 bits in total (3 bits for CC(g) index, and 6 bits for Beam ID) if the RSRP is not contained, or 16 bits if the RSRP is contained and reported by 7 bits. Besides, the PUCCH-resource is shared by all component carriers, and there is no need to handle BFRs for multiple component carriers at the same time. Thus, it is enough to allocate one physical resource block (PRB) for the BFR-PUCCH.

Only for illustrative purpose, an example of RRC configuration is given as follows:

BeamFailureRequestResourceConfig
::= SEQUENCE {

periodicityAndOffset
bfr-ProhibitTimer
bfr-TransMax
PUCCH-resource
PUCCH-TCIstates}

In the example beam failure request resource configuration, the first three parameters are used for BFR-PUCCH parameter configuration, the fourth one is used for the PUCCH-resource configuration indicate the PRB to be used and the last one is used to indicate the uplink transmit beams for the BFR-PUCCH.

In embodiments of the present disclosure, the BFR in the Scell is transmitted using the PUCCH resource in the Pcell. Thus, in a case of beam failures in both Pcell and Scell, the BFR-RACH for the Pcell has a higher priority than the BFR-PUCCH. In other words, in such a case, it shall first address the BFR in the Pcell and the BFR-PUCCH shall be transmitted after the process for the beam failure recovery for the Pcell is completed.

In addition, the BFR-PUCCH might have collision with other PUCCH. It was known that the terminal device can only transmit one PUCCH in the same OFDM symbol. However, there are multiple PUCCHs for different purposes and thus there might be a case in which more than one PUCCH is required to be transmitted in the same OFDM symbol. In such a case, a PUCCH collision happens.

In an embodiment of the present disclosure, it is proposed to use a simultaneous PUCCH transmission solution, in which the beam failure recovery request of the secondary cell is transmitted on the uplink control channel of the primary cell together with other control information. In another embodiment of the present disclosure, it is proposed to adopt a priority based transmission solution, in which the beam failure recovery request of the secondary cell is transmitted only when the beam failure recovery request of the secondary cell has a higher priority than other control information. Only for illustrative purposes, there are given serval example PUCCH collision cases to explain the BFR-PUCCH collision rule. However, the skilled in the art could understand that they are given only as examples and the present disclosure is not limited thereto. In fact, it is possible to apply the BFR-PUCCH collision rule to other collision cases than those illustrated.

### Collision Case 1—Scheduling Request (SR) and BFR-PUCCH

In this collision case, there are SR and BFR-PUCCH to be transmitted in the same OFDM symbol and there might be two different options. The first option is to transmit the SR PUCCH and the BFR-PUCCH simultaneously. For example, the PUCCH can have two bit fields, the first bit field bit-field 1 is used for BFR and the second bit field bit-field 2 is used for SR. As another option, it is also possible to adopt priority based transmission. For example, it may pre-define priorities of the SR and the BFR as any of 1) SR>BFR or 2) BFR>SR and the BFR-PUCCH is transmitted only if it has a higher priority than the SR. In such a case, the cc(g) index can be set as an index value larger than 1, which means SR being dropped and the BFR-PUCCH will be transmitted; On the other hand, it is possible to set the cc(g) index as 0 and drop BFR for the Scell.

Collision Case 2—Hybrid Automatic Repeat reQuest (HARQ) and BFR-PUCCH

For the case of collision between HARQ and BFR-PUCCH, there are two different options too. The first option is to transmit the HARQ and the BFR-PUCCH simultaneously. For example, if there is an HARQ and a negative BFR (no BFR is needed to be transmitted), the HARQ can be transmitted on HARQ-PUCCH resource. When there is HARQ and a positive BFR (both HARQ and BFR are required to be transmitted), the HARQ bits may be appended to the BFR bits, and both HARQ and BFR are transmitted on BFR-PUCCH resources. Thus, the network device may first detect HARQ PUCCH, and if there is no HARQ transmitted, it could further detect BFR PUCCH resource for the HARQ and BFR. The second option is to exploit the priority based transmission. For example, priorities of the HARQ and the BFR can be determined as 1) HARQ>BFR, i.e., and drop the BFR whenever it has a collision with HARQ.

### Collision Case 3—HARQ/SR/Channel State Information (CSI) and BFR-PUCCH

In this case, the first option is to transmit them in different bit fields on the PUCCH simultaneously. And the second option is to transmit them based on priority orders. The priority order may be determined any of:

1) SR/BFR/CSI-BM on other cell than the Scell having a BFR to be transmitted;

2) BFR/SR/CSI-BM on other cell than the Scell having a BFR to be transmitted;

3) SR/CSI-BM on the Scell having a BFR to be transmitted;

Based on these collision rules, the collision of the BFR with other control information could be address. Next, Reference is made back to FIG. 6 to continue the description of the beam failure processing solution as proposed herein.

As illustrated, in step 602, the terminal device may receive a response to the beam failure recovery request of the secondary cell (MSG 2) on a downlink control channel of the primary cell. Upon receiving the BFR-PUCCH, the gNB may send a response to the BFR-PUCCH. The response may be used to indicate a transmission configuration indication for a subsequent transmission. The response can be sent by downlink control information (DCI) which is scrambled by C-RNTI and transmitted on the downlink control channel of the Pcell, and enables a quick beam recovery/TCI reconfiguration. The network device may use an RRC signaling to configure a CORERSET for the response.

An example RRC CORRSET configuration for Scell BFR is given as follows for illustrative purposes:

RRC CORESET configuration for Scell BFR

| | |
|---|---|
| BeamFailureRecoveryCoresetConfig ::= | SEQUENCE { |

| | |
|---|---|
| recoveryControlResourceSetId | RecoveryControlResourceSet |

| | |
|---|---|
| recoverySearchSpaceId | SearchSpaceId |

| | |
|---|---|
| CellId | ServCellIndex, |

...
}

As mentioned hereinafter, the response to the beam failure recovery request of the secondary cell can be a DCI on the Pcell and it could be transmitted in a CORESET with many different configurations. For illustration purposes, several example possible configurations will be described hereinafter.

### Configuration 1—Reusing CORESET for BFR in the Pcell

In the configurations, the response for BFR in Scell will be transmitted on the CORESET reused from that for the response to BFR of the Pcell. In such a case, the terminal device could know that it is a response for the BFR in Pcell, if a BFR-PRACH was just transmitted for the Pcell and the TCI for the receiving beam of the response can be determined from the used PRACH resource. On the other hand, the terminal device could learn that it is a response for BFR in Scell if a BFR-PUCCH was just transmitted for the Scell. In such a case, the TCI for the receiving beam of the response can be explicitly configured by a RRC and/or MAC-CE signaling, or the terminal device just follows the receiving beam configuration for other Pcell CORESET, e.g., the most recently used CORESET or one of current active CORRESETs. For example, as illustrated in step 804 of FIG. 8, the terminal device may receive downlink transmission configuration indication information indicating a downlink reception beam used for receiving the downlink control channel of the primary cell used for transmitting the response to the beam failure recovery request of the secondary cell.

Regarding the target carrier of the response, the terminal device could derive the target carrier implicitly since the terminal device could know which carrier the BFR-PUCCH was transmitted for and thus it could derive it therefrom. As another choice, the target carrier identity transmission mode can be enabled so that the network device could transmit the target carrier ID in the DCI of the response to the beam failure recovery request of the secondary cell. For example, the network device could set cif-PresentInDCI as true by RRC for DCI 0_1 and 1-1 in the CORESET-BFR configuration. For illustrative purposes, an example of CORESET-BFR configuration is provided as follows:

recoveryControlResourceSet : : = SEQUENCE {
controlResourceSetIdControlResourceSetId,
tci-StatesPDCCH
cif-PresentInDCI
...
}

In such a case, the network node will contain a target carrier identity in the response to the beam failure recovery request of the Scell. Moreover, the terminal device would determine the target carrier from a target carrier identity contained therein.

### Configuration 2—Using Dedicated CORESET for BFR in the Scell

In this configuration, the response for BFR in Scell will be transmitted on a specific CORESET in Pcell dedicated for the Scell. Similarly, in such a case, the TCI can be explicitly configured by a RRC and/or MACE-CE signaling to indicate downlink receiving beams, or the terminal device just follows the receiving beam for other Pcell CORESET, e.g., the most recently used CORESET or one of current active CORRESETs.

The terminal device could derive the target carrier implicitly since the terminal device could know which carrier the BFR-PUCCH was transmitted for and thus it could derive it therefrom. As another choice, the target carrier identity transmission mode can be enabled so that the network device could transmit the target carrier ID in the response to the beam failure recovery request of the secondary cell. In such a case, the terminal device could determine the target carrier from a target carrier identity in the response to the beam failure recovery request of the Scell.

### Configuration 3—Using a Regular CORESET of Pcell

In this configuration, the response for BFR in Scell will be transmitted on a regular CORESET on Pcell instead of a specific one. In such a case, a cross-scheduling mode could be implicitly triggered after transmitting the BFR for the Scell. In the cross-scheduling mode, a target carrier identify will be contained for any CORESET and thus it could ensure that the response transmitted on any regular CORESET contains the target carrier identity.

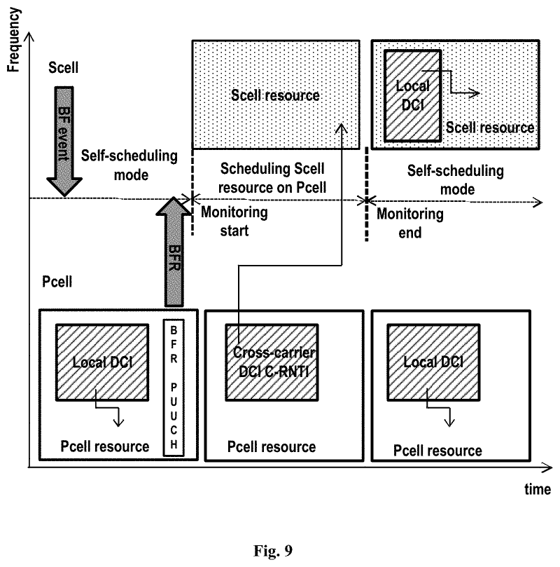

FIG. 9 further schematically illustrates resource scheduling for the beam failure recovery according to an embodiment of the present disclosure. As illustrated in FIG. 9, at first, both the Scell and Pcell operate in a self-scheduling mode, i.e., the Pcell and Scell schedules their respective resources with their local DCI. When a BF event occurs, an BFR-PUCCH will be transmitted to the network device by using Pcell's resource. During the monitoring window, the Scell resource will be scheduled by cross-carrier DCI scrambled by C-RNTI in Pcell for the beam recovery. Once the beam recovery is finished, both the Scell and Pcell return back to the self-scheduling mode. Thus, it can be seen that during the monitoring window, the Scell resource will be scheduled by Pcell for the beam recovery.

The monitoring window is a time duration in which the terminal device shall monitor the downlink CORESET for detecting information for beam failure recovery from network device. The monitoring window may start after transmitting the BFR-PUCCH and end when a time-out timer is expired, or a max counter is reached, or a predetermined condition is met.

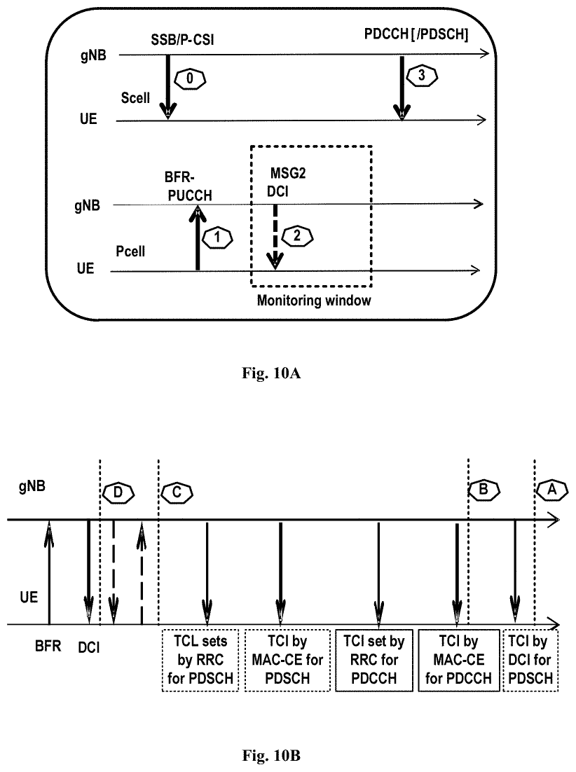

FIG. 10A illustrates an example process of the beam failure recovery and the monitoring window according to an embodiment of the present disclosure. As illustrated in FIG. 10A, first in step 0, the UE detects a beam failure in Scell, and then the UE transmits a BFR-PUCCH for the Scell in the Pcell (step 1). Next, a MSG 2 DCI is transmitted from the gNB to UE (step 2) as a response to the BFR-PUCCH. After this, the UE could receive the PDCCH/PDSCH in the Scell again (step 3). Until step 3, the UE needs monitoring the downlink CORESET in Pcell. The monitoring window may start after transmitting the BFR-PUCCH and end when a time-out timer is expired, or a max counter is reached, or a predetermined condition is met. FIG. 10B schematically illustrates several example possible end conditions for the monitoring window.

As illustrated in FIG. 10B, the first ending condition is upon receiving a cross-carrier transmission control information re-indication for downlink data channel on the secondary cell, as indicated by point A in FIG. 10B. In such a case, the Scell is ready to start regular PDCCH/PDSCH transmission with re-indicated TCI. The second ending condition is upon receiving a cross-carrier transmission control information re-indication for downlink control channel in the Scell as indicated by point B in FIG. 10B. In this case, the Scell is ready to start regular PDCCH transmission with re-indicated TCI. The third ending condition is upon completion of cross-carrier beam training as indicated by point C in FIG. 10B. After receiving DCI as response to the BFR, a cross-carrier beam training on Scell will be performed, and the completion of the cross-carrier beam training means that the terminal device could receive a cross-carrier transmission control information re-indication for downlink data channel/downlink control channel in the secondary cell. The fourth ending condition is upon receiving the response to the beam failure recovery request of the secondary cell.

In addition, in the CA in the NR system, there might be a case wherein a CCA succeeds but the beam fails and in such a case, it shall well address the detection of a beam failure. In the current NR system, the periodic synchronization signal block (SSB)/Channel State Indication-reference signal (CSI-RS) is used to measure channel state information, while in the unlicensed Scell, there is no SSB or CSI-RS.

To this end, in another aspect of the present disclosure, it is proposed to modify beam failure detection and new beam identification reference signal for the unlicensed Scell. Next, reference is made to FIG. 11 to describe the solution. As illustrated, in step 1101, the UE may receive a reference measurement configuration from the gNB, wherein this reference signal transmission could have a shorter burst and higher intensity than regular data transmission. The configuration may include measurement time window (L), transmission periodicity (P), and transmission offset (0). The measurement time window (L) indicates the measurement duration time for detecting reference signal, the transmission periodicity (P) indicates the periodicity of reference signal transmission, and the transmission offset (0) refers to the offset of the reference signal relative to the start boundary of a subframe.

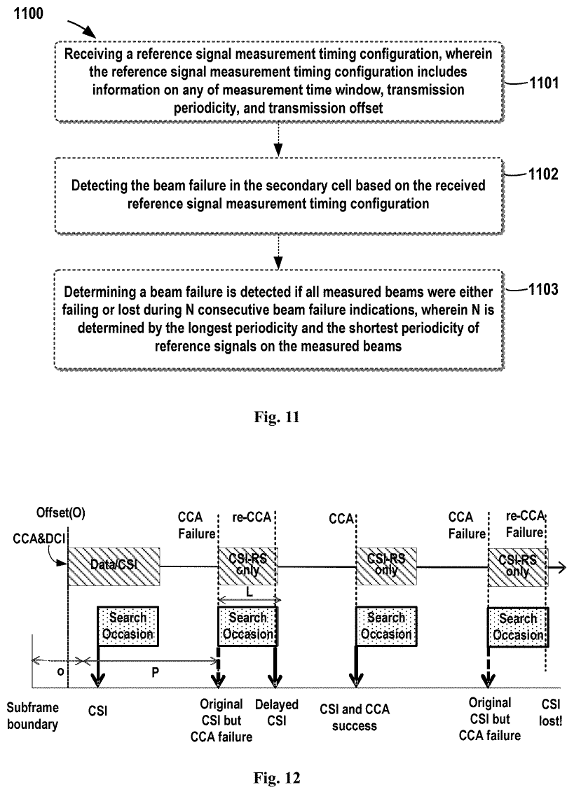

FIG. 12 schematically illustrates an example reference signal measurement timing configuration in secondary cell according to an embodiment of the present disclosure. As illustrated in FIG. 12, the CSI-RS is transmitted with a periodicity of P and an offset of 0, the UE searches the CSI-RS during the measurement time window L. As illustrated, in a case of CCA failure, a re-CAA could be performed during the search occasion defined by the measurement time window L and the delayed CSI-RS could be transmitted to the UE if the re-CAA succeeds. On the other hand, if the re-CAA fails until the ending of the measurement time window, the gNB will not transmit the CSI-RS to the UE and thus a CSI loss happens.

Reference is made back to FIG. 11 and description will be continued with operations of beam failure detection. In step 1102, the terminal device may detect the beam failure in the secondary cell based on the received reference signal measurement timing configuration. Further in step 1103, the terminal device may determine a bam failure if all measured beams were either failing or lost during N consecutive beam failure indications, wherein N is determined by the longest periodicity and the shortest periodicity of reference signals on the measured beams.

In the NR system, a beam failure indication (BFI) is periodical and a BFI interval is determined by the shortest periodicity of reference signals (RS) for beam failure detection. An RS cannot be transmitted in case of CCA failure or it is not on its transmission timing. In embodiments of the present disclosure, if all measured RSs for beam failure detection are either lost or failing during N consecutive BFI intervals, the terminal device will determine that there is a beam failure event. The number of consecutive BFIs is determined by the longest periodicity and the shortest periodicity of reference signals on the measured beams. As an example, N is determined by ceiling the result of the longest periodicity divided by the shortest periodicity of reference signals for the beam failure detection. In such a way, it could ensure all the reference signals for beam failure detection could be measured at least once during N consecutive BFI intervals.

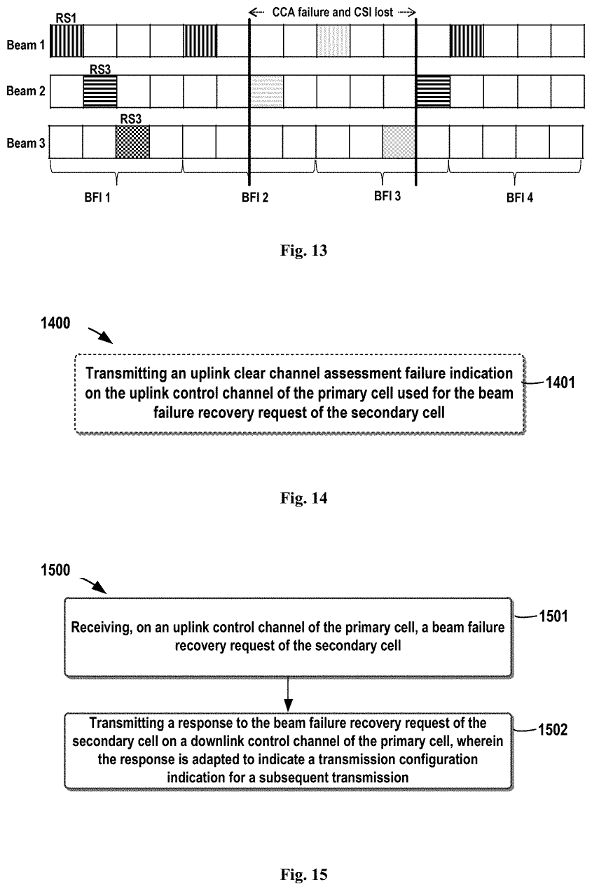

For illustrative purposes, FIG. 13 schematically illustrates an example beam failure detection in the secondary cell according to an embodiment of the present disclosure. As illustrated in FIG. 13, there are three beams (beam 1, beam 2 and beam 3) to be measured and three reference signals RS1, RS2, RS3 are used for three beams respectively as beam failure detection RSs. The periodicity of RS1 is 4 slots, the periodicity of RS2 is 5 slots and the periodicity of RS3 is 8 slots. Thus, the BFI has a periodicity of 4 and the beam failure is required to detected in two consecutive BFI (8/4=2). As illustrated in FIG. 13, in the time interval as indicated by two bold lines, there is a CCA failure and CSI lost. Thus the UE fails to detect all reference signals which should be measured in this time interval and thus a beam failure indication is counted. After N consecutive BFI is counted, the beam failure event is detected and determined.

In an embodiment of the present disclosure, the Scell may have both DL and UL, in such a case there might be three events at gNB after a DL transmission. The first one is CAA failure in UL, if the UE does not inform gNB with a CCA failure in UL, a DTX detection and a retransmission will be used. The second one is a PDCCH missing or error at the UE, and in such a case, the gNB also adopts the DTX detection and retransmission solution. The third one is beam failure in DL in such a case, DTX detection does not work well here and retransmission does not help either. However, the UE can differentiate the first event from the third one. In such a case, it is possible to multiplex UL CAA failure on BFR-PUCCH resource.

In an embodiment of the present disclosure, the terminal device could reuse the uplink control channel of the primary cell used for the beam failure request of the secondary cell to transmit an uplink clear channel assessment failure indication, as illustrated in step 1401 of FIG. 14. In such a case, if the UL CCA failure is detected at a gNB, the gNB could hold the retransmission until the UL CAA is good. On the other hand, if a beam failure in the Scell is detected, a BFR response could be transmitted to the UE.

Next, reference will be made to FIGS. 15 to 18 to describe example methods of processing beam failure at the network device according to embodiments of the present disclosure.

Reference is first made to FIG. 15, which schematically illustrates a flow chart of a method for processing beam failure of the secondary cell at a network device according to an embodiment of the present disclosure. In an embodiment of the present disclosure, a terminal device is serviced by the network device in a primary cell and a secondary cell on separate beams, and the secondary cell operates in a self-scheduling mode. As illustrated in FIG. 15, in step 1501, a beam failure recovery request of the secondary cell can be received on an uplink control channel of the primary cell. As mentioned above, in the present disclosure, the beam failure recovery request will be carried on the uplink control channel of the primary cell and the network could know it is a BFR for the secondary cell since it is on the uplink control channel instead of PRACH.

Then in step 1502, the network device could transmit a response to the beam failure recovery request of the secondary cell on a downlink control channel of the primary cell, wherein the response is configured to indicate a transmission configuration indication for a subsequent transmission. In other words, the response to the beam failure recovery request is carried on the control channel on the primary cell.

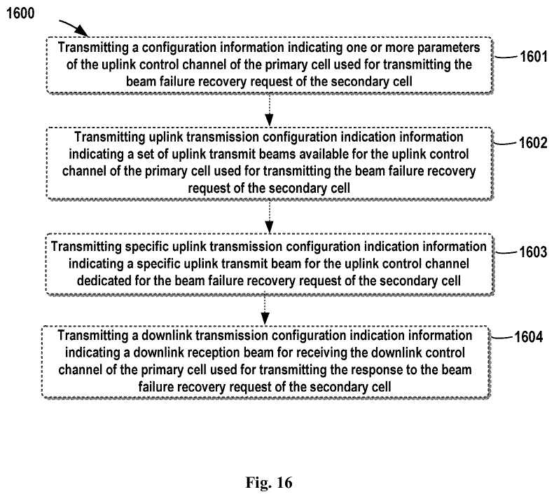

In an embodiment of the present disclosure, it is possible to pre-configure the uplink control channel of the primary cell used for transmitting the beam failure recovery request of the secondary cell. As illustrated in FIG. 16, in step 1601, the network may transmit configuration information to the terminal device to indicate one or more parameters of the uplink control channel of the primary cell used for transmitting the beam failure recovery request of the secondary cell. The one or more parameters may include, for example, one or more of transmission periodicity, transmission offset, transmission prohibit timer, and a maximum number of transmissions.

In another embodiment of the present disclosure, the network device could also configure the transmit beams for the uplink control channel of the primary cell used for transmitting the beam failure recovery request of the secondary cell. As illustrated in step. 1602, the network may first transmit uplink transmission configuration indication information to indicate a set of uplink transmit beams available for the uplink control channel of the primary cell used for transmitting the beam failure recovery request of the secondary cell. Then, in step 1603, it may transmit specific uplink transmission configuration indication information to indicate a specific uplink transmit beam for the uplink control channel dedicated for the beam failure recovery request of the secondary cell. Thus, the beam failure recovery request of the secondary cell is received with the specific uplink transmit beam on the uplink control channel dedicated for the beam failure recovery request of the secondary cell.

In another embodiment of the present disclosure, the network device does not configure the uplink transmit beam, but receive the beam failure recovery request of the secondary cell on a most recently used uplink transmit beam.

In a further embodiment of the present disclosure, the beam failure recovery request of the secondary cell could be received on the uplink control channel of the primary cell together with other control information. Or alternatively, the beam failure recovery request of the secondary cell can be received only when the beam failure recovery request of the secondary cell has a higher priority than other control information.

In addition, in a case of beam failures in both the primary cell and the secondary cell, the beam failure recovery request of the secondary cell is received after a process for the beam failure recovery in the primary cell is completed.

In an embodiment of the present disclosure, the response to the beam failure recovery request of the secondary cell can be transmitted on a control resource set for a beam failure response of the primary cell. In another embodiment of the present disclosure, the response to the beam failure recovery request of the secondary cell can be transmitted on a control resource set of the primary cell specific to the response to the beam failure recovery request of the secondary cell. In both cases, a target carrier of the response can be implicitly derived, or a target carrier identity transmission mode is enabled for the response to the beam failure recovery request of the secondary cell to contain a target carrier identity in the response to the beam failure recovery request of the secondary cell. In a further embodiment of the present disclosure, the response to the beam failure recovery request of the secondary cell can be transmitted on a regular control resource set of the primary cell. In this case, the cross-scheduling mode can be enabled during a monitoring window of the response to the beam failure recovery request of the secondary cell to contain a target carrier identity in the response to the beam failure recovery request of the secondary cell.

In another embodiment of the present disclosure, the network device may further configure the downlink reception beam for the response to the beam failure recovery request of the secondary cell. As illustrated in FIG. 16, in step 1604, the network device may further transmit downlink transmission configuration indication information indicating a downlink reception beam for receiving the downlink control channel of the primary cell used for transmitting the response to the beam failure recovery request of the secondary cell. Or alternatively, the network device will transmit the response to the beam failure recovery request of the secondary cell on a most recently used downlink reception beam.

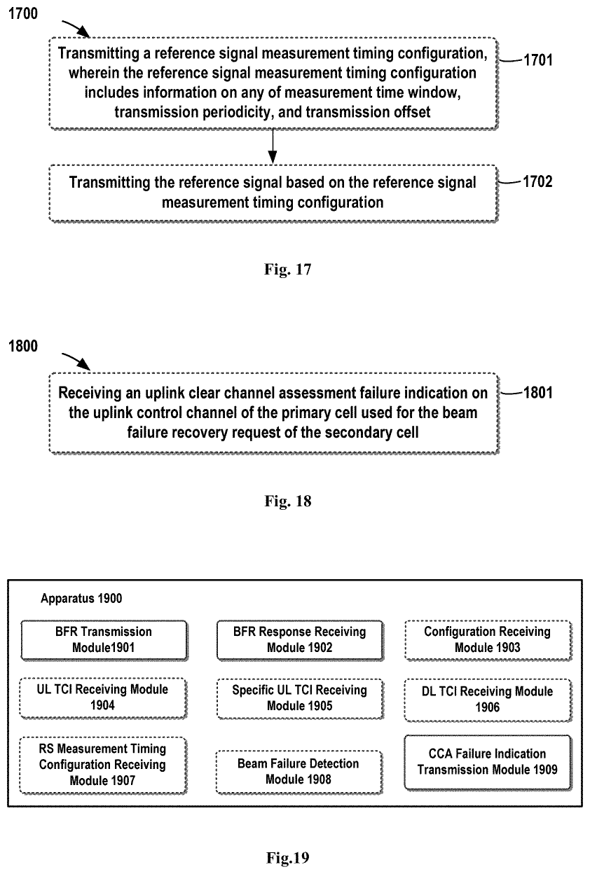

In an embodiment of the present disclosure, the network device may further configure the reference signal measurement timing. As illustrated in FIG. 17, in step 1701, the network device may transmit a reference signal measurement timing configuration. The reference signal measurement timing configuration includes information on any of measurement time window, transmission periodicity, and transmission offset. Then in step 1702, the network device could transmit the reference signal based on the reference signal measurement timing configuration.

In a further embodiment of the present disclosure, the network device may receive an uplink clear channel assessment failure indication on the uplink control channel of the primary cell used for the beam failure recovery request of the secondary cell. In such a way, the CCA failure indication could be multiplexed on the uplink control channel of the primary cell used for the beam failure recovery request of the secondary cell.

Hereinabove, example methods of processing beam failure at the network side are described in brief hereinbefore with reference to FIGS. 15 to 18. However, it can be understood that operations at the network device are corresponding to those at the terminal device and thus for some details of operations, one may refer to description with reference to FIGS. 6 to 14.

FIG. 19 further schematically illustrates a block diagram of an apparatus for processing beam failure at a terminal device according to an embodiment of the present disclosure. The apparatus 1900 can be implemented at a terminal device, for example UE or other like terminal devices. The terminal device is serviced in a primary cell and a secondary cell on separate beams, and the secondary cell operates in a self-scheduling mode.

As illustrated in FIG. 1900, the apparatus 1900 may include a BFR transmission module 1901 and a BFR response receiving module 1902. The BFR transmission module 1901 may be configured to transmit, on an uplink control channel of the primary cell, a beam failure recovery request of the secondary cell, in response to detection of a beam failure in the secondary cell. The BFR response receiving module 1902 may be configured to receive a response to the beam failure recovery request of the secondary cell on a downlink control channel of the primary cell, wherein the response is configured to indicate a transmission configuration indication for a subsequent transmission.

In an embodiment of the present disclosure, the apparatus 1900 may further comprise a configuration receiving module 1903. The configuration receiving module 1903 may be configured to receive a configuration information indicating one or more parameters of the uplink control channel of the primary cell used for transmitting the beam failure recovery request of the secondary cell. The one or more parameters include, for example, one or more of transmission periodicity, transmission offset, transmission prohibit timer, and a maximum number of transmissions.

In another embodiment of the present disclosure, the apparatus 1900 may further comprise an UL TCI receiving module 1904 and a specific UL TCI receiving module 1905. The UL TCI receiving module 1904 may be configured to receive uplink transmission configuration indication information indicating a set of uplink transmit beams available for the uplink control channel of the primary cell used for transmitting the beam failure recovery request of the secondary cell. The specific UL TCI receiving module 1905 may be configured to receive specific uplink transmission configuration indication information indicating a specific uplink transmit beam for the uplink control channel dedicated for the beam failure recovery request of the secondary cell. In such a case, the beam failure recovery request of the secondary cell can be transmitted with the specific uplink transmit beam on the uplink control channel dedicated for the beam failure recovery request of the secondary cell.

In a further embodiment of the present disclosure, the beam failure recovery request of the secondary cell is transmitted on a most recently used uplink transmit beam.

In a still further embodiment of the present disclosure, the beam failure recovery request of the secondary cell is transmitted on the uplink control channel of the primary cell together with other control information. Or alternatively, the beam failure recovery request of the secondary cell is transmitted only when the beam failure recovery request of the secondary cell has a higher priority than other control information.

In another embodiment of the present disclosure, in response to detection of beam failures in both the primary cell and the secondary cell, the beam failure recovery request of the secondary cell can be transmitted after a process for the beam failure recovery in the primary cell is completed.

In a further embodiment of the present disclosure, the response to the beam failure recovery request of the secondary cell is received on any one of:
a control resource set for a beam failure response of the primary cell, wherein a target carrier of the response is implicitly derived, or determined from a target carrier identity contained in the response to the beam failure recovery request of the secondary cell;
a control resource set of the primary cell specific to the response to the beam failure recovery request of the secondary cell, wherein the target carrier of the response is implicitly derived, or determined from a target carrier identity contained in the response to the beam failure recovery request of the secondary cell; and
a regular control resource set of the primary cell, wherein the cross-scheduling mode is enabled during a monitoring window of the response to the beam failure recovery request of the secondary cell to determine the target carrier from a target carrier identity contained in the response to the beam failure recovery request of the secondary cell.

In a still further embodiment of the present disclosure, the apparatus 1900 may further comprise a DL TCI receiving module 1906, which can be configured to receive a downlink transmission configuration indication information indicating a downlink reception beam for receiving the downlink control channel of the primary cell used for transmitting the response to the beam failure recovery request of the secondary cell. In such a case, the response to the beam failure recovery request of the secondary cell is received on a most recently used reception beam.

In yet further embodiment of the present disclosure, the downlink control resource of the primary cell is monitored to receive the response to the beam failure recovery request of the secondary cell. The monitoring starts after transmitting the beam failure recovery request of the secondary cell and ends upon any of: receiving a cross-carrier transmission control re-indication for downlink data channel on the secondary cell; receiving a cross-carrier transmission control re-indication for downlink control channel on the secondary cell; completion of a cross-carrier beam training; and receiving the response to the beam failure recovery request of the secondary cell.

In another embodiment of the present disclosure, the apparatus 1900 may further comprise an RS measurement timing configuration receiving module 1907 and a beam failure detection module 1908. The RS measurement timing configuration receiving module 1907 may be configured to receive a reference signal measurement timing configuration, wherein the reference signal measurement timing configuration includes information on any of measurement time window, transmission periodicity, and transmission offset. The beam failure detection module 1908 may be configured to detect the beam failure in the secondary cell based on the received reference signal measurement timing configuration.

In another embodiment of the present disclosure, the beam failure detection module 1908 may be configured to determine that a bam failure is detected if all measured beams were either failing or lost during N consecutive beam failure indications, wherein N is determined by the longest periodicity and the shortest periodicity of reference signals on the measured beams.

In a further embodiment of the present disclosure, the apparatus 1900 may further comprise a CCA failure indication transmission module 1909. The CCA failure indication transmission module 1909 may be configured to transmit an uplink clear channel assessment failure indication on the uplink control channel of the primary cell used for the beam failure recovery request of the secondary cell to further indicate a clear channel assessment failure for an uplink transmission.

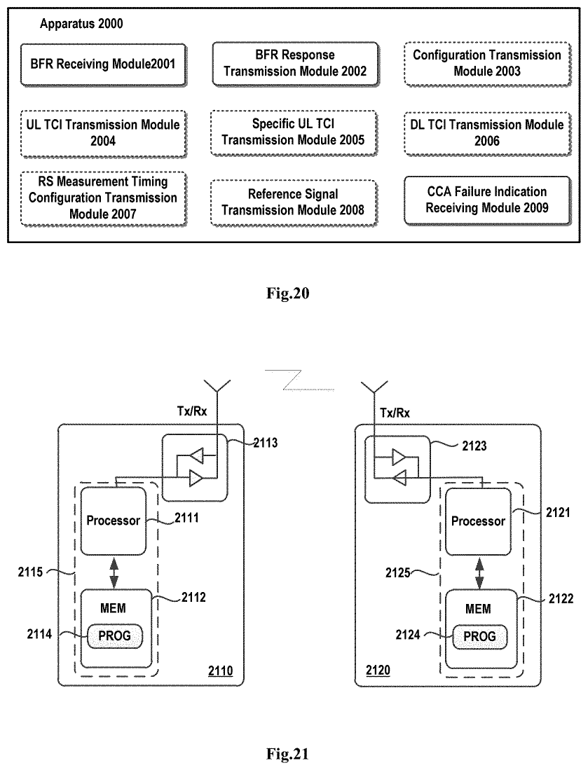

FIG. 20 schematically illustrates a block diagram of an apparatus for processing the beam failure of the secondary cell at a network device according to an embodiment of the present disclosure. The Apparatus 2000 could be implemented on the network device or node for example gNB, or other like network devices. The terminal device is serviced in a primary cell and a secondary cell on separate beams, and the secondary cell operates in a self-scheduling mode.

As illustrated in FIG. 2000 the apparatus 2000 may include a BFR receiving module 2001 and a BFR response transmission module 2002. The BFR receiving module 2001 may be configured to receive, on an uplink control channel of the primary cell, a beam failure recovery request of the secondary cell. The BFR response transmission module 2002 may be configured to transmit a response to the beam failure recovery request of the secondary cell on a downlink control channel of the primary cell, wherein the response is configured to indicate a transmission configuration indication for a subsequent transmission.

In an embodiment of the present disclosure, the apparatus 2000 may further comprise a configuration transmission module 2003. The configuration transmission module 1903 may be configured to transmit configuration information indicating one or more parameters of the uplink control channel of the primary cell used for transmitting the beam failure recovery request of the secondary cell. The one or more parameters include, for example, one or more of transmission periodicity, transmission offset, transmission prohibit timer, and a maximum number of transmissions.

In another embodiment of the present disclosure, the apparatus 2000 may further comprise an UL TCI transmission module 2004 and a specific UL TCI transmission module 2005. The UL TCI transmission module 2004 may be configured to transmit uplink transmission configuration indication information indicating a set of uplink transmit beams available for the uplink control channel of the primary cell used for transmitting the beam failure recovery request of the secondary cell. The specific UL TCI transmission module 2005 may be configured to transmit specific uplink transmission configuration indication information indicating a specific uplink transmit beam for the uplink control channel dedicated for the beam failure recovery request of the secondary cell. In such a case, the beam failure recovery request of the secondary cell can be received with the specific uplink transmit beam on the uplink control channel dedicated for the beam failure recovery request of the secondary cell.

In a further embodiment of the present disclosure, the beam failure recovery request of the secondary cell can be received on a most recently used uplink transmit beam.

In a still further embodiment of the present disclosure, the beam failure recovery request of the secondary cell is received on the uplink control channel of the primary cell together with other control information. Or alternatively, the beam failure recovery request of the secondary cell is received only when the beam failure recovery request of the secondary cell has a higher priority than other control information.

In another embodiment of the present disclosure, in a case of beam failures in both the primary cell and the secondary cell, the beam failure recovery request of the secondary cell is received after a process for the beam failure recovery in the primary cell is completed.

In a further embodiment of the present disclosure, the response to the beam failure recovery request of the secondary cell may be transmitted on any one of:
a control resource set for a beam failure response of the primary cell, wherein a target carrier of the response is implicitly derived, or a target carrier identity transmission is enabled for the response to the beam failure recovery request of the secondary cell to contain a target carrier identity in the response to the beam failure recovery request of the secondary cell;
a control resource set of the primary cell specific to the response to the beam failure recovery request of the secondary cell, wherein the target carrier of the response is implicitly derived, or the target carrier identity transmission is enabled for the response to the beam failure recovery request of the secondary cell to contain a target carrier identity in the response to the beam failure recovery request of the secondary cell; and
a regular control resource set of the primary cell, wherein the cross-scheduling mode is enabled during a monitoring window of the response to the beam failure recovery request of the secondary cell to contain a target carrier identity in the response to the beam failure recovery request of the secondary cell.

In a still further embodiment of the present disclosure, the apparatus 20000 may further comprise a DL TCI transmission module 2006, which can be configured to transmit a downlink transmission configuration indication information indicating a downlink reception beam for receiving the downlink control channel of the primary cell used for transmitting the response to the beam failure recovery request of the secondary cell. In such a case, the response to the beam failure recovery request of the secondary cell is transmitted on a most recently used downlink reception beam.

In another embodiment of the present disclosure, the apparatus 2000 may further comprise an RS measurement timing configuration transmission module 2007 and a RS transmission module 2008. The RS measurement timing configuration transmission module 2007 may be configured to transmit a reference signal measurement timing configuration, wherein the reference signal measurement timing configuration includes information on any of measurement time window, transmission periodicity, and transmission offset. The RS transmission module 2008 may be configured to transmit the reference signal based on the reference signal measurement timing configuration.

In a further embodiment of the present disclosure, the apparatus 2000 may further comprise a CCA failure indication receiving module 2009. The CCA failure indication receiving module 2009 may be configured to receive an uplink clear channel assessment failure indication on the uplink control channel of the primary cell used for the beam failure recovery request of the secondary cell.

Hereinbefore, apparatuses 1900 to 2000 are described with reference to FIGS. 19 to 20 in brief. It can be noted that the apparatuses 1900 to 2000 may be configured to implement functionalities as described with reference to FIGS. 6 to 18. Therefore, for details about the operations of modules in these apparatuses, one may refer to those descriptions made with respect to the respective steps of the methods with reference to FIGS. 6 to 18.

It is further noted that components of the apparatuses 1900 to 2000 may be embodied in hardware, software, firmware, and/or any combination thereof. For example, the components of apparatuses 1900 to 2000 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1900 to 2000 may include at least one processor. The at least one processor suitable for use with embodiments of the present disclosure may include, by way of example, both general and special purpose processors already known or developed in the future. Apparatuses 1900 to 2000 may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 1900 to 2000 to at least perform operations according to the method as discussed with reference to FIGS. 6 to 18 respectively.

FIG. 21 schematically illustrates a simplified block diagram of an apparatus 2110 that may be embodied as or comprised in a terminal device like UE, and an apparatus 2120 that may be embodied as or comprised in a network device like gNB as described herein.

The apparatus 2110 comprises at least one processor 2111, such as a data processor (DP) and at least one memory (MEM) 2112 coupled to the processor 2111. The apparatus 2110 may further include a transmitter TX and receiver RX 2113 coupled to the processor 2111, which may be operable to communicatively connect to the apparatus 2120. The MEM 2112 stores a program (PROG) 2114. The PROG 2114 may include instructions that, when executed on the associated processor 2111, enable the apparatus 2110 to operate in accordance with embodiments of the present disclosure, for example method 600, 800, 1100, 1400. A combination of the at least one processor 2111 and the at least one MEM 2112 may form processing means 2115 adapted to implement various embodiments of the present disclosure.

The apparatus 2120 comprises at least one processor 2111, such as a DP, and at least one MEM 2122 coupled to the processor 2111. The apparatus 2120 may further include a suitable TX/RX 2123 coupled to the processor 2121, which may be operable for wireless communication with the apparatus 2110. The MEM 2122 stores a PROG 2124. The PROG 2124 may include instructions that, when executed on the associated processor 2121, enable the apparatus 2120 to operate in accordance with the embodiments of the present disclosure, for example to perform method 1500, 1600, 1700 and 1800. A combination of the at least one processor 2121 and the at least one MEM 2122 may form processing means 2125 adapted to implement various embodiments of the present disclosure.

Various embodiments of the present disclosure may be implemented by computer program executable by one or more of the processors 2111, 2121, software, firmware, hardware or in a combination thereof.

The MEMs 2112 and 2122 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 2111 and 2121 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

What is claimed is:

1. A method for processing a beam failure at a terminal device, wherein the terminal device is serviced in a primary cell and a secondary cell on separate beams, and the secondary cell operates in a self-scheduling mode, the method comprising:
transmitting, on an uplink control channel of the primary cell, a beam failure recovery request of the secondary cell, in response to detection of a beam failure in the secondary cell; and
receiving a response to the beam failure recovery request of the secondary cell on a downlink control channel of the primary cell, wherein the response is configured to indicate a transmission configuration indication for a subsequent transmission.

2. The method of claim 1, further comprising:
receiving a configuration information indicating one or more parameters of the uplink control channel of the primary cell used for transmitting the beam failure recovery request of the secondary cell,
wherein the one or more parameters include one or more of transmission periodicity, transmission offset, transmission prohibit timer, and a maximum number of transmissions.

3. The method of claim 1 or 2, further comprising:
receiving uplink transmission configuration indication information indicating a set of uplink transmit beams available for the uplink control channel of the primary cell used for transmitting the beam failure recovery request of the secondary cell; and
receiving specific uplink transmission configuration indication information indicating a specific uplink transmit beam for the uplink control channel dedicated for the beam failure recovery request of the secondary cell,
wherein the beam failure recovery request of the secondary cell is transmitted with the specific uplink transmit beam on the uplink control channel dedicated for the beam failure recovery request of the secondary cell.

4. The method of claim 1 or 2, wherein the beam failure recovery request of the secondary cell is transmitted on a most recently used uplink transmit beam.

5. The method of claim 1 or 2, wherein the beam failure recovery request of the secondary cell is transmitted on the uplink control channel of the primary cell together with other control information; or
wherein the beam failure recovery request of the secondary cell is transmitted only when the beam failure recovery request of the secondary cell has a higher priority than other control information.

6. The method of claim 1 or 2, wherein in response to detection of beam failures in both the primary cell and the secondary cell, the beam failure recovery request of the secondary cell is transmitted after a process for the beam failure recovery in the primary cell is completed.

7. The method of claim 1 or 2, wherein the response to the beam failure recovery request of the secondary cell is received on any one of:
a control resource set for a beam failure response of the primary cell, wherein a target carrier of the response is implicitly derived, or determined from a target carrier identity contained in the response to the beam failure recovery request of the secondary cell;
a control resource set of the primary cell specific to the response to the beam failure recovery request of the secondary cell, wherein the target carrier of the response is implicitly derived, or determined from a target carrier identity contained in the response to the beam failure recovery request of the secondary cell; and
a regular control resource set of the primary cell, wherein the cross-scheduling mode is enabled during a monitoring window of the response to the beam failure recovery request of the secondary cell to determine the target carrier from a target carrier identity contained in the response to the beam failure recovery request of the secondary cell.

8. The method of claim 1 or 2, wherein the method further comprises receiving a downlink transmission configuration indication information indicating a downlink reception beam for receiving the downlink control channel of the primary cell used for transmitting the response to the beam failure recovery request of the secondary cell; or
wherein the response to the beam failure recovery request of the secondary cell is received on a most recently used reception beam.

9. The method of claim 8, wherein the downlink control resource of the primary cell is monitored to receive the response to the beam failure recovery request of the secondary cell, and wherein the monitoring starts after transmitting the beam failure recovery request of the secondary cell and ends upon any of:
receiving a cross-carrier transmission control re-indication for downlink data channel on the secondary cell;
receiving a cross-carrier transmission control re-indication for downlink control channel on the secondary cell;
completion of a cross-carrier beam training; and
receiving the response to the beam failure recovery request of the secondary cell.

10. The method of claim 1 or 2, further comprising:
receiving a reference signal measurement timing configuration, wherein the reference signal measurement timing configuration includes information on any of measurement time window, transmission periodicity, and transmission offset; and
detecting the beam failure in the secondary cell based on the received reference signal measurement timing configuration.

11. The method of claim 1 or 2, further comprising:
determining that a bam failure is detected if all measured beams were either failing or lost during N consecutive beam failure indications, wherein N is determined by the longest periodicity and the shortest periodicity of reference signals on the measured beams.

12. The method of claim 1 or 2, further comprising transmitting an uplink clear channel assessment failure indication on the uplink control channel of the primary cell used for the beam failure recovery request of the secondary cell to further indicate a clear channel assessment failure for an uplink transmission.

13. A method for processing a beam failure at a network device, wherein a terminal device is serviced by the network device in a primary cell and a secondary cell on separate beams, and the secondary cell operates in a self-scheduling mode, the method comprising:
receiving, on an uplink control channel of the primary cell, a beam failure recovery request of the secondary cell; and
transmitting a response to the beam failure recovery request of the secondary cell on a downlink control channel of the primary cell, wherein the response is configured to indicate a transmission configuration indication for a subsequent transmission.

14. The method of claim 13, further comprising:
transmitting configuration information indicating one or more parameters of the uplink control channel of the primary cell used for transmitting the beam failure recovery request of the secondary cell,
wherein the one or more parameters include one or more of transmission periodicity, transmission offset, transmission prohibit timer, and a maximum number of transmissions.

15. The method of claim 13 or 14, further comprising:
transmitting uplink transmission configuration indication information indicating a set of uplink transmit beams available for the uplink control channel of the primary cell used for transmitting the beam failure recovery request of the secondary cell; and
transmitting specific uplink transmission configuration indication information indicating a specific uplink transmit beam for the uplink control channel dedicated for the beam failure recovery request of the secondary cell,
wherein the beam failure recovery request of the secondary cell is received with the specific uplink transmit beam on the uplink control channel dedicated for the beam failure recovery request of the secondary cell.

16. The method of claim 13 or 14, wherein the beam failure recovery request of the secondary cell is received on a most recently used uplink transmit beam.

17. The method of claim 13 or 14, wherein the beam failure recovery request of the secondary cell is received on the uplink control channel of the primary cell together with other control information; or
wherein the beam failure recovery request of the secondary cell is received only when the beam failure recovery request of the secondary cell has a higher priority than other control information.

18. The method of claim 13 or 14, wherein in a case of beam failures in both the primary cell and the secondary cell, the beam failure recovery request of the secondary cell is received after a process for the beam failure recovery in the primary cell is completed.

19. The method of claim 13 or 14, wherein the response to the beam failure recovery request of the secondary cell is transmitted on any one of:
a control resource set for a beam failure response of the primary cell, wherein a target carrier of the response is implicitly derived, or a target carrier identity transmission is enabled for the response to the beam failure recovery request of the secondary cell to contain a target carrier identity in the response to the beam failure recovery request of the secondary cell;
a control resource set of the primary cell specific to the response to the beam failure recovery request of the secondary cell, wherein the target carrier of the response is implicitly derived, or the target carrier identity transmission is enabled for the response to the beam failure recovery request of the secondary cell to contain a target carrier identity in the response to the beam failure recovery request of the secondary cell; and
a regular control resource set of the primary cell, wherein the cross-scheduling mode is enabled during a monitoring window of the response to the beam failure recovery request of the secondary cell to contain a target carrier identity in the response to the beam failure recovery request of the secondary cell.

20. The method of claim 13 or 14, wherein the method further comprises transmitting a downlink transmission configuration indication information indicating a downlink reception beam for receiving the downlink control channel of the primary cell used for transmitting the response to the beam failure recovery request of the secondary cell; or
wherein the response to the beam failure recovery request of the secondary cell is transmitted on a most recently used downlink reception beam.

21. The method of claim 13 or 14, further comprising:
transmitting a reference signal measurement timing configuration, wherein the reference signal measurement timing configuration includes information on any of measurement time window, transmission periodicity, and transmission offset; and
transmitting the reference signal based on the reference signal measurement timing configuration.

22. The method of claim 13 or 14, further comprising:
receiving an uplink clear channel assessment failure indication on the uplink control channel of the primary cell used for the beam failure recovery request of the secondary cell.

23. A terminal device, wherein the terminal device is serviced in a primary cell and a secondary cell on separate beams, and the secondary cell operates in a self-scheduling mode, the terminal device comprising:
a transceiver, configured to transmit, on an uplink control channel of the primary cell, a beam failure recovery request of the secondary cell, in response to detection of a beam failure in the secondary cell; and
a receiver configured to receive a response to the beam failure recovery request of the secondary cell on a downlink control channel of the primary cell, wherein the response is adapted to indicate a transmission configuration indication for a subsequent transmission.

24. A network device, wherein a terminal device is serviced by the network device in a primary cell and a secondary cell on separate beams, and the secondary cell operates in a self-scheduling mode, the network device comprising:
a receiver configured to receive, on an uplink control channel of the primary cell, a beam failure recovery request of the secondary cell; and
a transceiver, configured to transmit a response to the beam failure recovery request of the secondary cell on a downlink control channel of the primary cell to indicate a transmission configuration indication for a subsequent transmission.

25. A terminal device, comprising
a processor, and
a memory coupled with the processor and having program codes therein, which, when executed on the processor, cause the terminal device to perform operations of any of claims 1 to 12.

26. A network device, comprising
a processor, and
a memory coupled with the processor and having program codes therein, which, when executed on the processor, cause the network device to perform operations of any of claims 13 to 22.
